(19) United States
(12) Patent Application Publication
(10) Pub. No.: US 2026/0070390 A1
(43) Pub. Date: Mar. 12, 2026

(54) VEHICLE SUSPENSION SYSTEM

(71) Applicant: Terex South Dakota, Inc., Watertown, SD (US)

(72) Inventor: Brian M. CLARK, Seattle, MI (US)

(21) Appl. No.: 18/883,725

(22) Filed: Sep. 12, 2024

(51) Int. Cl. B60G 17/056; B60G 11/30; B60G 17/015

(52) U.S. Cl. CPC B60G 17/056; B60G 11/30; B60G 17/0152; B60G 2202/15; B60G 2202/41; B60G 2300/06; B60G 2400/204; B60G 2400/60; B60G 2500/20; B60G 2600/182

(57) ABSTRACT

A fluid suspension system for a land vehicle is provided with a fluid biasing member with a first fluid port and a second fluid port. The fluid biasing member is adapted to be connected to a chassis and a first axle of a land vehicle spaced apart from a pivotal connection of the first axle to pivot the first axle relative to the chassis upon movement to a first position and a second position. A proportional valve is in fluid cooperation with the first fluid port of the fluid biasing member to permit fluid to flow to the fluid biasing member to bias the fluid biasing member to the first position, and to permit the fluid to flow from the fluid biasing member to the proportional valve, and to the second fluid port of the fluid biasing member to bias the fluid biasing member to the second position.

### TECHNICAL FIELD

Various embodiments relate to suspension systems for land vehicles.

### BACKGROUND

Barnhartt U.S. Pat. No. 5,447,331 issued to Genie Industries, Inc., on Sep. 5, 1995, for a Vehicle Axle Oscillation System with Positive Ground Contact, which discloses a fluid suspension system for a land vehicle.

Clark et al., U.S. Pat. No. 11,623,492 B2 issued to Terex South Dakota, Inc., on Apr. 11, 2023, for a Vehicle Suspension System, which discloses a fluid suspension system for a land vehicle.

Clark et al., U.S. Pat. No. 11,623,493 B2 issued to Terex South Dakota, Inc., on Apr. 11, 2023, for a Vehicle Suspension System, which discloses a fluid suspension system for a land vehicle.

### SUMMARY

According to an embodiment, a suspension system for a land vehicle is provided with a biasing member adapted to be connected to a chassis and a first axle of a land vehicle spaced apart from a pivotal connection of the first axle to pivot the first axle relative to the chassis upon movement to a first position and a second position. A proportional input is in cooperation with the biasing member to permit proportional movement of the biasing member to the first position, and to the second position.

According to a further embodiment, the biasing member is further provided as a fluid biasing member with a first fluid port and a second fluid port. The proportional input is further provided as a proportional valve assembly in fluid cooperation with the first fluid port of the fluid biasing member to permit fluid to flow to the fluid biasing member to bias the fluid biasing member to the first position, and to permit the fluid to flow from the fluid biasing member to the proportional valve assembly, and to the second fluid port of the fluid biasing member to bias the fluid biasing member to the second position.

According to an even further embodiment, the proportional valve assembly is provided with a proportional valve, and a second valve that is in fluid cooperation with the fluid biasing member to permit the fluid to flow from the fluid biasing member and the proportional valve to the second valve, and to the fluid biasing member to bias the fluid biasing member to the second position.

According to another further embodiment, a fluid pressure circuit provides the fluid cooperation of the fluid biasing member and the proportional valve assembly.

According to an even further embodiment, the fluid pressure circuit is further provided with an inlet to receive pressurized fluid to charge the fluid pressure circuit.

According to another even further embodiment, the fluid pressure circuit is further provided with an accumulator.

According to another further embodiment, a controller is provided in operable communication with the proportional valve assembly and is programmed to: receive input indicative of unbalanced forces on the first axle, and adjust the proportional valve assembly in response to the input.

According to another further embodiment, a controller is provided in operable communication with the proportional valve assembly and programmed to: receive input indicative of a travel speed of the land vehicle, and adjust the proportional valve assembly in response to the travel speed within a predetermined range.

According to another further embodiment, a pressure relief valve is provided in parallel with the proportional valve assembly.

According to an even further embodiment, the pressure relief valve is further provided as a thermal pressure relief valve.

According to another further embodiment, the fluid biasing member is further defined as a first fluid biasing member. The fluid suspension system is further provided with a second fluid biasing member with a third fluid port and a fourth fluid port. The second fluid biasing member is adapted to be connected to the chassis and the first axle of the land vehicle spaced apart from the pivotal connection of the first axle and spaced apart from the first fluid biasing member to pivot the first axle relative to the chassis upon movement to the first position and the second position. A second valve is in fluid cooperation with the third fluid port of the second fluid biasing member to permit fluid to flow to the second fluid biasing member to bias the second fluid biasing member to the second position, and to permit the fluid to flow from the second fluid biasing member to the second valve, and to the fourth fluid port of the second fluid biasing member to bias the second fluid biasing member to the first position.

According to another embodiment, a land vehicle is provided with a chassis, a first axle pivotally connected to the chassis about a horizontal axis perpendicular to the first axle, and a pair of wheels mounted to the first axle and spaced apart with the pivotal connection therebetween to support the first axle and the chassis for travel upon an underlying support surface. A fluid suspension system is provided with a fluid biasing member with a first fluid port and a second fluid port. The fluid biasing member is connected to the chassis and the first axle of a land vehicle spaced apart from the pivotal connection of the first axle to pivot the first axle relative to the chassis upon movement to a first position and a second position. A proportional valve assembly is in fluid cooperation with the first fluid port of the fluid biasing member to permit fluid to flow to the fluid biasing member to bias the fluid biasing member to the first position, and to permit the fluid to flow from the fluid biasing member to the proportional valve assembly, and to the second fluid port of the fluid biasing member to bias the fluid biasing member to the second position. A fluid pressure circuit is in cooperation with the fluid biasing member and the proportional valve assembly.

According to a further embodiment, a second axle is pivotally connected to the chassis about the horizontal axis perpendicular to the second axle and spaced apart from the first axle. A second pair of wheels is mounted to the second axle and spaced apart with the pivotal connection of the second axle and the chassis therebetween to support the second axle and the chassis for travel upon the underlying support surface. A sensor is in cooperation with the second axle to detect a pivotal position of the second axle relative to the chassis.

According to another embodiment, a fluid suspension system for a land vehicle is provided with a fluid biasing member adapted to be connected to a chassis and a first axle of a land vehicle spaced apart from a pivotal connection of the first axle to pivot the first axle relative to the chassis upon movement to a first position and a second position. A first valve is in fluid cooperation with the fluid biasing member to permit fluid to flow to the fluid biasing member to bias the fluid biasing member to the first position. A second valve is in fluid cooperation with the fluid biasing member and the first valve to permit the fluid to flow from the fluid biasing member to the first valve, to the second valve, and to the fluid biasing member to bias the fluid biasing member to the second position.

According to a further embodiment, the first valve is further provided with a proportional valve.

According to another further embodiment, a fluid pressure circuit provides the fluid cooperation of the fluid biasing member, the first valve, and the second valve.

According to an even further embodiment, the fluid pressure circuit is further provided with an inlet to receive a pressurized fluid to charge the fluid pressure circuit.

According to another further embodiment, the fluid biasing member is further defined as a first fluid biasing member. The fluid suspension system is further provided with a second fluid biasing member adapted to be connected to the chassis and the first axle of the land vehicle spaced apart from the pivotal connection of the first axle and spaced apart from the first fluid biasing member to pivot the first axle relative to the chassis upon movement to the first position and the second position. A third valve is in fluid cooperation with the second fluid biasing member to permit fluid to flow to the second fluid biasing member to bias the second fluid biasing member to the second position. A fourth valve is in fluid cooperation with the second fluid biasing member and the third valve to permit the fluid to flow from the second fluid biasing member to the third valve, to the fourth valve, and to the second fluid biasing member to bias the second fluid biasing member to the first position.

According to another embodiment, a land vehicle is provided with a chassis, a first axle pivotally connected to the chassis about a horizontal axis perpendicular to the first axle, and a pair of wheels mounted to the first axle and spaced apart with the pivotal connection therebetween to support the first axle and the chassis for travel upon an underlying support surface. A fluid suspension system for the land vehicle is provided with a fluid biasing member connected to the chassis and the first axle of the land vehicle spaced apart from the pivotal connection of the first axle to pivot the first axle relative to the chassis upon movement to a first position and a second position. A first valve is in fluid cooperation with the fluid biasing member to permit fluid to flow to the fluid biasing member to bias the fluid biasing member to the first position. A second valve is in fluid cooperation with the fluid biasing member and the first valve to permit the fluid to flow from the fluid biasing member to the first valve, to the second valve, and to the fluid biasing member to bias the fluid biasing member to the second position. A fluid pressure circuit is in cooperation with the fluid biasing member, the first valve, and the second valve.

According to a further embodiment, a second axle is pivotally connected to the chassis about the horizontal axis perpendicular to the second axle and spaced apart from the first axle. A second pair of wheels is mounted to the second axle and spaced apart with the pivotal connection of the second axle and the chassis therebetween to support the second axle and the chassis for travel upon the underlying support surface. A sensor is in cooperation with the second axle to detect a pivotal position of the second axle relative to the chassis.

According to another embodiment, a fluid suspension system for a land vehicle is provided with a first fluid biasing member adapted to be connected to a chassis and a first axle of a land vehicle spaced apart from a pivotal connection of the first axle to pivot the first axle relative to the chassis upon movement to a first position and a second position. A second fluid biasing member is adapted to be connected to the chassis and the first axle of the land vehicle spaced apart from the pivotal connection of the first axle and spaced apart from the first fluid biasing member to pivot the first axle relative to the chassis upon movement to the first position and the second position. A first valve is in fluid cooperation with the first fluid biasing member to permit fluid to flow to the first fluid biasing member to bias the first fluid biasing member to the first position. A second valve is in fluid cooperation with the first fluid biasing member and the first valve to permit the fluid to flow from the first fluid biasing member to the first valve, to the second valve, and to the first fluid biasing member to bias the first fluid biasing member to the second position. A third valve is in fluid cooperation with the second fluid biasing member and the second valve, to permit fluid to flow from the first fluid biasing member and the second valve to the third valve, and then to the second fluid biasing member to bias the second fluid biasing member to the second position. A fourth valve is in fluid cooperation with the second fluid biasing member, the first valve, and the third valve to permit the fluid to flow from the first fluid biasing member and the first valve to the fourth valve, and fluid from the second fluid biasing member and the third valve to the fourth valve, and to the second fluid biasing member to bias the second fluid biasing member to the first position.

### BRIEF DESCRIPTION OF THE DRAWINGS

FIG. 1 is a perspective of an aerial lift vehicle according to an embodiment, illustrated in a partially extended position;

FIG. 2 is a perspective view of an aerial lift vehicle according to another embodiment, illustrated partially extended;

FIG. 3 is a schematic end view of an axle assembly of a land vehicle according to another embodiment;

FIG. 4 is a schematic end view of another axle assembly of the land vehicle of FIG. 3;

FIG. 5 is a fluid circuit diagram of a suspension system of the land vehicle of FIG. 3 according to an embodiment; and

FIG. 6 is a schematic diagram of a control system for the suspension system of FIG. 5.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

It will also be understood that, although the terms first, second, etc. are, in some instances, used herein to describe various elements in order of introduction, these elements should not be limited by these terms. These terms are only used to distinguish one element from another. For example, a first valve could be termed a second valve, and, similarly, a second valve could be termed a first valve, without departing from the scope of the various described embodiments. The first valve and the second valve are both valves, but they are not the same valve.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The terminology controller may be provided as one or more controllers or control modules for the various components and systems. The controller 88 and control system may include any number of controllers, and may be integrated into a single controller, or have various modules. Some or all of the controllers may be connected by a controller area network (CAN) or other system. It is recognized that any controller, circuit, or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

Aerial lift assemblies provide an operator platform on a linkage assembly that pivots and/or translates to lift the operator platform to an elevated worksite. Conventional aerial lift assemblies include various adjustable structures to lift an operator platform to a height for performing a work operation. The aerial lift assemblies often include a stack linkage assembly. The aerial lift assemblies often include an articulated boom assembly, which may be provided by a four-bar linkage mechanism or an extending riser type linkage. Aerial lift assemblies are often provided on land vehicles for transportation of operator platform to the worksite.

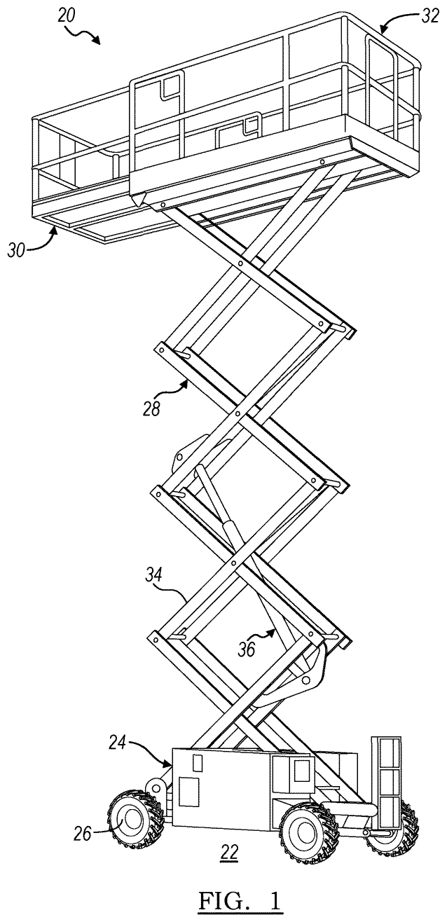

FIG. 1 illustrates an aerial lift assembly 20 according to an embodiment. The aerial lift assembly 20 is a mobile aerial lift assembly 20 as a land vehicle, which is collapsible for transportation upon an underlying support surface 22, such as the ground or a floor (FIG. 1). The aerial lift assembly 20 is also transportable for towing and transport upon a trailer behind a truck. The aerial lift assembly 20 is expandable by operator control to lift an operator to an elevated worksite. The aerial lift assembly 20 is discussed with relation to the ground 22. Therefore, terms such as upper, lower, and other height related terms are relative to height from the ground 22 are not to limit the aerial lift assembly 20 to ground 22 specific applications.

The aerial lift assembly 20 includes a lift structure that provides significant stability and performance characteristics by elevating a worker to an advantageous position for reach while providing stability. The aerial lift assembly 20 includes a chassis 24 to support the aerial lift assembly 20 upon the ground 22 or any support surface. The chassis 24 is supported upon a plurality of wheels 26 that contact the ground 22. A linkage assembly 28 is connected to the chassis 24 to extend and retract from the chassis 24. A platform 30 is provided on the linkage assembly 28 to extend and retract from the chassis 24. The platform 30 includes perimeter railing 32 extending upward from the platform 30 to enclose an operator workspace upon the platform 30.

The aerial lift assembly 20 is utilized to lift the platform 30 and workers to elevated work locations to perform work operations. The linkage assembly 28 is a stack linkage assembly 28, with a series of pivotally connected stack links 34 that retract to collapse and stack upon the chassis 24 for compactness for storage and transportation. The aerial lift assembly 20 also includes an actuator assembly 36 to extend and retract the linkage assembly 28 and consequently, extend and retract the platform 30.

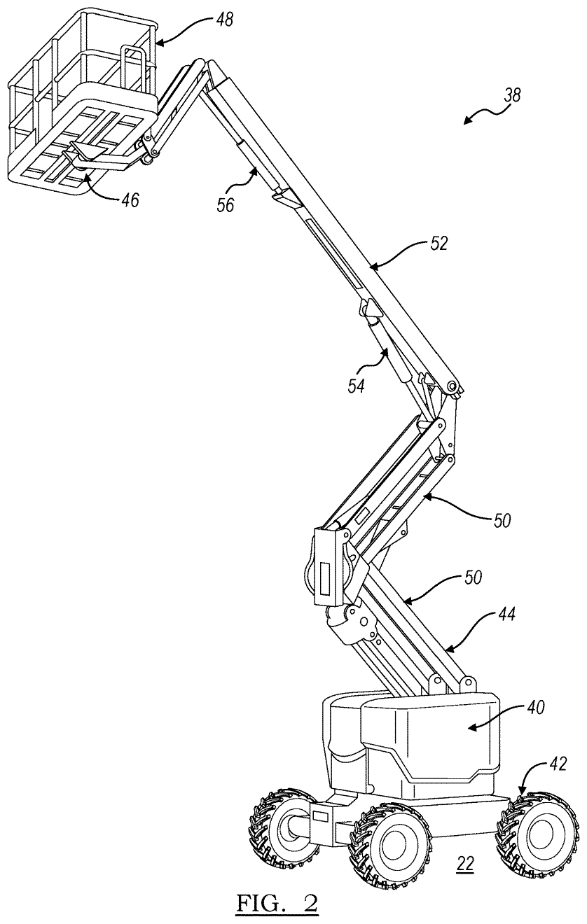

FIG. 2 illustrates an aerial lift assembly 38 according to another embodiment. The aerial lift assembly 38 includes a chassis 40 to support the aerial lift assembly 38 upon the ground 22. The chassis 40 is supported upon a plurality of wheels 42 that contact the ground 22 for support and mobility of the aerial lift assembly 38. A linkage assembly 44 is connected to the chassis 40 to extend and retract from the chassis 40. A platform 46 is provided on the linkage assembly 44 with a perimeter railing 48. The linkage assembly 44 includes a plurality of four bar linkages 50 with an extendable boom 52. Actuator assemblies 54 are provided to pivot the four bar linkages 50 and the extendable boom 52. An actuator assembly 56 is provided to extend the boom 52.

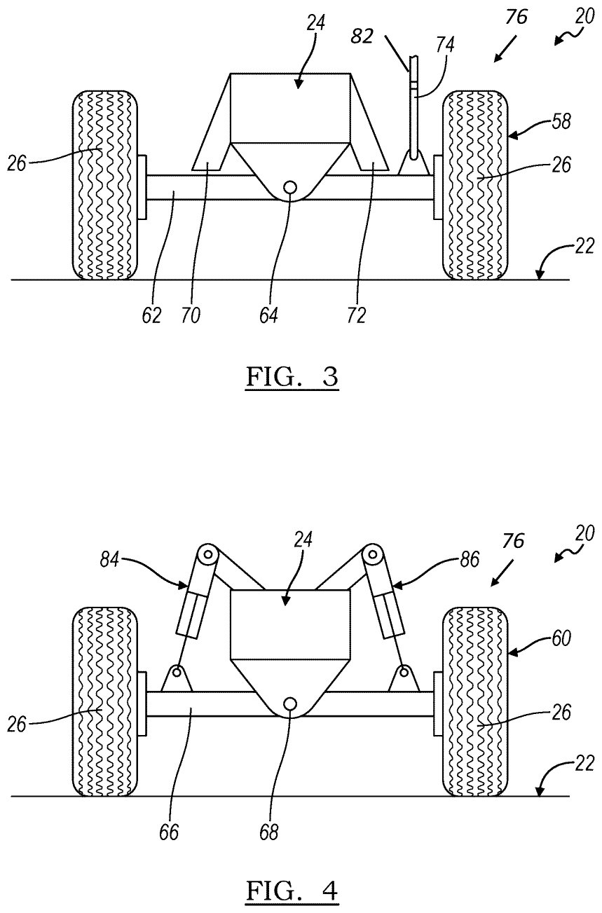

FIG. 3 illustrates an end view of an axle assembly 58 of the land vehicle 20, which may be a rear axle assembly 58 according to an embodiment. FIG. 4 illustrates an end view of an axle assembly 60 of the land vehicle 20, which may a front axle assembly 60. The chassis 24 is supported upon the pair of axle assemblies 58, 60. The chassis 24 is pivotally connected to a rear axle 62 of the rear axle assembly 58 at a rear pivot pin 64. The rear pivot pin 64 is located centrally upon the rear axle 62 and is oriented horizontally in a fore and aft travel direction of the land vehicle 20, which is perpendicular to the rear axle 62. The chassis 24 is pivotally connected to a front axle 66 of the front axle assembly 60 at a front pivot pin 68. The front pivot pin 68 is located centrally upon the front axle 66 and is also oriented horizontally in the fore and aft travel direction of the land vehicle 20, which is perpendicular to the front axle 66. The front axle assembly 60 may be steerable, as is known in the art. The wheels 26 are mounted for rotation upon the axle assemblies 58, 60 to support the axle assemblies 58, 60 upon the ground 22. Some of, or all of, the wheels 26 may be driven by a motor or a plurality of motors, as is known in the art.

The pivoting of the axle assemblies 58, 60 permits a suspension of the land vehicle 20 to maintain contact of the wheels 26 with the ground 22 as the wheels 26 traverse inconsistencies on the ground 22. The pivoting axle assemblies 58, 60 are often referred to as an oscillation suspension system 76. One function of the oscillation suspension system 76 is to maintain ground contact normal force to prevent loss of traction. Another function of the oscillation suspension system 76 is to lock the axle assembly 60 in place when motion would reduce the stability of the vehicle 20. Another function of the oscillation suspension system 76 is to prevent any of the wheels 26 from lifting significantly off the ground 22, which is undesirable because changes in terrain can cause rock-over onto the lifted wheel 26 when the projected center of gravity crosses a diagonal line between wheels 26 on opposite corners of the land vehicle 20.

Pivoting of the rear axle assembly 58 is limited in the angular pivot range. For example, the rear axle assembly 58 may be permitted to pivot about one degree (or less) in either angular direction. Hard stops 70, 72 are provided on the chassis 24 and extend toward the rear axle 62. As the rear axle assembly 58 approaches inconsistencies on the ground 22, the rear axle 62 can be pivoted in either direction until contact with one of the hard stops 70, 72, thereby limiting the pivoting of the pivot range. The suspension system 76 cooperates with the front and rear axle assemblies 58, 60 to adjust the front axle assembly 60 in response to the pivoting of the rear axle assembly 58. The adjustment may cooperate such that if one of the stops 70, 72 is engaged by the rear axle 62, the front axle 66 is pivoted in a reverse angular direction to keep the wheels 26 in contact with the ground.

Pivoting of the right or left pivoting direction of the rear axle 62 is sensed by the suspension system 76. An input link 74 is pivotally connected to the rear axle 62 to translate as the rear axle 62 pivots. The input link 74 cooperates with the suspension system 76 so that the translation of the input link 74 is detected by the suspension system 76.

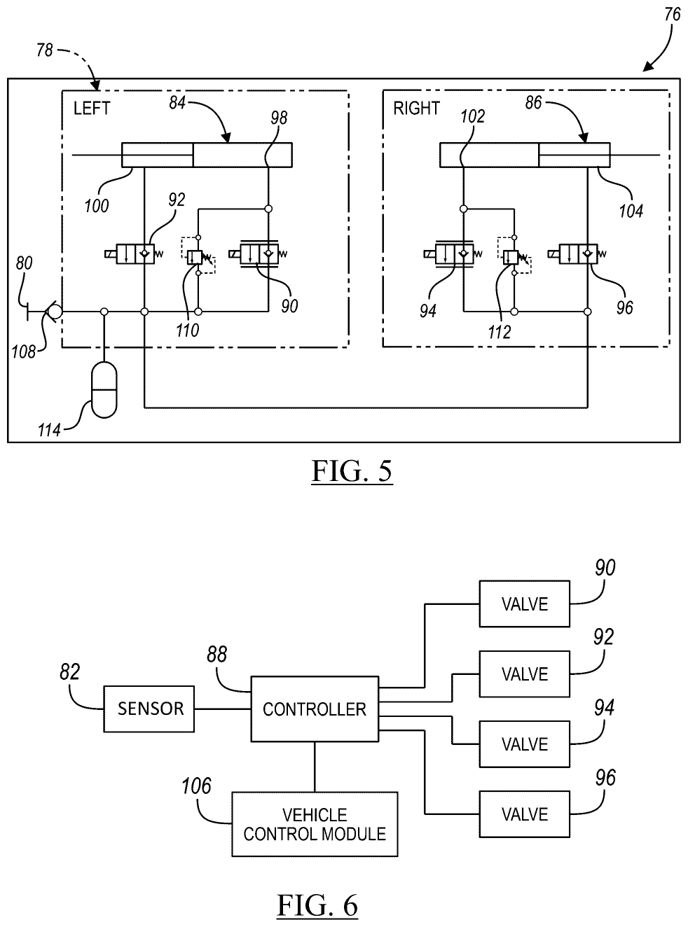

FIG. 5 illustrates a portion of the suspension system 76 as a fluid circuit diagram. According to one embodiment, the suspension system 76 is a fluid suspension system 76. According to another embodiment, the suspension system 76 is a hydraulic suspension system 76. The suspension system 76 includes a fluid pressure circuit 78, such as a hydraulic pressure circuit 78. The pressure circuit 78 is a closed circuit 78 that is charged or pressurized before operation, according to a depicted embodiment. The circuit 78 includes an inlet 80 for receipt of pressurized fluid to charge the circuit 78 with a source of pressurized fluid. According to another embodiment, the suspension system 76 may include a pump that is connected at the inlet 80 for pressurizing the fluid.

Referring again to FIG. 3, the input link 74 cooperates with a sensor 82 on the chassis 24. The sensor 82 detects the pivot direction of the rear axle 62 based upon the translation of the input link 74. The sensor 82 is a limit switch 82 according to one embodiment. In one embodiment, the sensor 82 is a directional switch 82 with a neutral position when the rear axle 62 is in a balanced position. Further extension of the input link 74 indicates one pivotal direction to a first pivoted position of the rear axle 62 indicative of unbalanced forces on the rear axle 62. Retraction of the input link 74 from the neutral position indicates pivoting in the opposite direction to a second pivoted position of the rear axle 62. Although one input link 74 is illustrated and described, any number of input links 74 may be employed. According to another embodiment, the sensor 82 is extended to detect the rear axle 62; and the input link 74 is omitted. According to another embodiment, the sensor 82 is a proximity sensor 82.

Referring again to FIG. 4, a pair of biasing members 84, 86 are provided on the front axle 66. According to another embodiment, only one biasing member 84 or 86 is utilized. A biasing member 84, 86 may be a member or mechanism that biases motion to resist motion, permit motion, and/or provide motion. The biasing member 84, 86 may be acted upon or actuated. The biasing members 84, 86 may be a damper, a dashpot, a regulator, a spring, a linear actuator, a rotary actuator, a brake, or the like. The biasing members 84, 86 may be adjustable, lockable, motion resistant, speed resistant, force resistant, balancing, variable, proportional, braking, force absorbing, force dissipating, or the like. The biasing members 84, 86 may be acted upon or actuated by fluid pressure, motion, electric input, or the like.

According to the depicted embodiment, the biasing members 84, 86 are hydraulic cylinders 84, 86, which also referred to as hydraulic actuators 84, 86. Each of the hydraulic cylinders 84, 86 is pivotally connected to the front axle 66 and the chassis 24, and the hydraulic cylinders 84, 86 are spaced apart with the chassis 24 therebetween. According to another embodiment, any number of cylinders 84, 86 may be employed, such as one cylinder 84. The cylinders 84, 86 operate to receive a fluid pressure input, and provide a mechanical output as linear motion. The cylinders 84, 86 also operate to receive a mechanical input, such as linear motion, and to provide a fluid pressure output.

With reference now to FIG. 6, the sensor 82 is in communication with a controller 88 to convey signals indicative of positions of the axle 62. The controller 88 is also in communication with a plurality of valves 90, 92, 94, 96. As illustrated in FIG. 5, each of the valves 90, 92, 94, 96 is in fluid communication within the fluid pressure circuit 78. The first valve 90 is a normally closed proportional solenoid valve 90. The first valve 90 is in fluid communication with a first port 98 of the first biasing member 84. In the normally closed position, the first valve 90 operates as a check valve permitting pressurized fluid into the first biasing member 84 to extend or maintain the first biasing member 84, while preventing egress of the fluid from the first biasing member 84. The controller 88 cooperates with the first valve 90 to bias the first valve 90 to an open position, whereby fluid may egress the first biasing member 84 thereby permitting retraction of the first biasing member 84 to pivot the axle 66 to a first position. The first valve 90 may be a proportional poppet valve 90 whereby the controller 88 controls a position of the first valve 90 to control a rate of flow of fluid from the first biasing member 84 during retraction of the first biasing member 84.

The second valve 92 is in fluid communication with a second port 100 of the first biasing member 84. The second valve 92 is a normally closed solenoid valve 92. In the normally closed position, the second valve 92 operates as a check valve permitting pressurized fluid into the first biasing member 84 to retract or maintain the first biasing member 84, while preventing egress of the fluid from the first biasing member 84. The controller 88 cooperates with the second valve 92 to bias the second valve 92 to an open position, whereby fluid may egress the first biasing member 84 thereby permitting extension of the first biasing member 84 to pivot the axle 66 to a second position. According to another embodiment, the second valve 92 may be a proportional poppet valve 92 whereby the controller 88 controls a position of the second valve 92 to control a rate of flow of fluid from the first biasing member 84 during extension of the first biasing member 84.

The third valve 94 is a normally closed proportional solenoid valve 94. The third valve 94 is in fluid communication with a first port 102 of the second biasing member 86. In the normally closed position, the third valve 94 operates as a check valve permitting pressurized fluid into the second biasing member 86 to extend or maintain the second biasing member 86, while preventing egress of the fluid from the second biasing member 86. The controller 88 cooperates with the third valve 94 to bias the third valve 94 to an open position, whereby fluid may egress the second biasing member 86 thereby permitting retraction of the second biasing member 86 to pivot the axle 66 to the first position. The third valve 94 may be a proportional poppet valve 94 whereby the controller 88 controls a position of the third valve 94 to control a rate of flow of fluid from the second biasing member 86 during retraction of the second biasing member 86.

The fourth valve 96 is in fluid communication with a second port 104 of the second biasing member 86. The fourth valve 96 is a normally closed solenoid valve 96. In the normally closed position, the fourth valve 96 operates as a check valve permitting pressurized fluid into the second biasing member 86 to retract or maintain the second biasing member 86, while preventing egress of the fluid from the second biasing member 86. The controller 88 cooperates with the fourth valve 96 to bias the fourth valve 96 to an open position, whereby fluid may egress the second biasing member 86 thereby permitting extension of the second biasing member 86 to pivot the axle 66 to the second position. According to another embodiment, the fourth valve 96 may be a proportional poppet valve 96 whereby the controller 88 controls a position of the fourth valve 96 to control a rate of flow of fluid from the second biasing member 86 during extension of the second biasing member 86. According to yet another embodiment, all of the biasing member valves 90, 92, 94, 96 may be nonproportional valves.

In normal operation, pressure is applied through both valves 90, 92, 94, 96 of each biasing member 84, 86. Opening of any valve 90, 92, 94, 96 permits egress of fluid from the respective port 98, 100, 102, 104 back to the system 76. To coordinate movement, or extension and retraction of the biasing members 84, 86 opposite valves 90, 92, 94, 96 are opened. For example, when the first valve 90 is opened to retract the left biasing member 84, the fourth valve 96 is opened to extend the right biasing member 86 to pivot the axle 66 to the first position. Likewise, when the third valve 94 is opened to retract the right biasing member 86, the second valve 92 is opened to extend the left biasing member 84 to pivot the axle 66 to the second position.

Referring now to FIGS. 3-5, the suspension system 76 permits the axles 62, 66 to oscillate, while maintaining traction by allowing the front axle 66 to pivot to follow terrain of the underlying surface 22 without transmitting additional motion to the chassis 24 that may reduce stability of the vehicle 20.

The hydraulic suspension system 76 omits pumped flow according to some embodiments. For an electric vehicle 20 using a battery instead of an engine, omission of a pump saves significant energy to not have to pump flow for the oscillate suspension system 76. Omission of a pump results in more cycles per charge or permits a smaller battery. Likewise, a significant reduction in weight upon the suspension system 76 is obtained in comparison to prior art vehicles with an engine and a pump. Likewise, hydraulic fluid lines are minimized without the pump. The oscillate suspension system 76 permits ease to set up the system 76, since the limit sensor(s) 82 or proximity sensor(s) 82 can be individually mounted and adjusted.

As illustrated in FIG. 4, the oscillate cylinders 84, 86 constrain the motion of the front axle 66 to pivot around the center pin 68 whose axis is aligned with the direction of travel of the vehicle 20. Free pivoting of the axle 66 about the pin 68 permits the wheels 26 to remain in contact with the ground 22, but without such constraints, the stability of the vehicle 20 can be somewhat compromised. The cylinders 84, 86 allow motion when helpful to keep the wheels 26 in contact with the ground 22, for traction purposes, and the cylinders 84, 86 restrict motion when such motion might cause a reduction in stability. The detection for allowing or denying motion is built around the pivoting rear axle 62, that is constrained by travel stops 70, 72 so that the axle 62 can move freely from stop 70 to stop 72. The pivot angle of the rear axle 62 is less than one degree, according to an embodiment.

When the center of gravity of the vehicle 20, projected vertically to the ground 22, is inside a triangle defined by the two front wheel 26 contact points with the ground 22, and the rear axle pivot pin center 64, then the rear axle 62 can follow the terrain 22 and move from stop 70 to stop 72 as the terrain 22 rises and falls. When the rear axle 62 is pushed to the stop 70 on one side, it signals the control system 88 (FIG. 6) to allow the oscillate cylinder 86 on the opposite corner to retract.

In comparison to the prior art, signaling of the position of the rear axle 62 is conveyed electronically, instead of hydraulically. The electronic signaling omits additional valves. According to an embodiment, the oscillate cylinders 84, 86 are locked and unlocked by electric solenoid valves 90, 92, 94, 96. By employing two valves 90, 92, 94, 96 per cylinder 84, 86, redundancy is provided.

In the hydraulic system 76, fluid flow can be scaled relative to drive speed by partially opening or closing the proportional valve assemblies 90, 94. The proportional valve assemblies 90, 94 may include individual proportional valves 90, 94 as shown, or may include the proportional valves 90, 94 in combination with other valves. As illustrated in FIG. 6, the controller 88 may also communicate with a vehicle control module 106 to receive a travel speed of the vehicle 20. The flow to the biasing members 84, 86 is regulated by controlling current to a solenoid coil of the two proportional poppet valves 90, 94, which are connected to the barrel side of the biasing members 84, 86 at ports 98, 102. The valves 92, 96 that are connected to the rod side of the biasing members 84, 86 could be proportional valves to also regulate flow in retraction of the biasing members 84, 86. Each of the valves 90, 92, 94, 96 is controlled by the system controller 88, as signaled by the sensor(s) 82 sensing the rear axle 62 position. For redundancy, redundant sensors 82 may also be employed to detect the axle 62 position. Alternatively, two sensors 82 may be utilized in combination with one rotation sensor at the pivot pin 64 for additional redundancy.

The hydraulic system 76 provides an oscillate suspension system 76 without requiring a pump. The hydraulic system 76 is a closed loop hydraulic system 76 that is charged at the inlet 80 at assembly. A check valve 108 is provided between the inlet 80 and the valves 90, 92, 94, 96 to close the loop. The valves 90, 92, 94, 96 are enabled by the controller 88 in response to the axle sensors 82. Flow command to the proportional coils 90, 94 is proportional to drive speed. For example, low fluid flow is permitted at low vehicle speeds. The biasing members 84, 86 are sized with a sufficient cylinder area, so that if any valves 90, 92, 94, 96 fails in an open position, the opposite cylinder 84, 86 has sufficient working area to hold a load at a relief setting of the valve 90, 92, 94, 96.

In operation, when the sensors 82 detect that the rear axle 62 is raised to the left, the right side biasing member 86 is operated with the third valve 94 open and the second valve 92 is open to retract the right biasing member 86 and to extend the left biasing member 84. The biasing members 84, 86 may also include position sensors to convey the biasing member positions to the controller 88. The quantity of the sensors may also be repeated for redundancy.

The poppet valves 90, 92, 94, 96 do not require external hydraulic flow to signal the valves 90, 92, 94, 96 to open. Overextending of the axle 66 is avoided, thereby preventing lifting a wheel 26 off the ground 22. Since no flow is required from a pump, there is no power required to move the fluid, so the system 76 is more efficient than prior art pumped systems. Since the hydraulic suspension system 76 is a closed system, no hydraulic hoses need to pass through a swing bearing, and no connections are needed at a manifold.

The proportional poppet valves 90, 94 allow speed regulation to happen at the cylinders 84, 86, under electrical control. This dramatically reduces part count and complexity of hydraulic system 76. Regulating the flow electrically at the cylinders provides cost effective scaling of the axle 66 pivot speed to the drive speed.

When driving with the lift structure stowed, the system 76 can be put into ‘float’ mode by opening all of the solenoid valves 90, 92, 94, 96, allowing fluid to move back and forth with minimal restriction.

Since the hydraulic suspension system is not connected to a pump, the system 76 is charged with hydraulic fluid at assembly, and any trapped air can be removed. Thermal expansion in a trapped volume creates additional pressure. Thermal pressure relief valves 110, 112 are provided in parallel to the proportional poppet valves 90, 94 to relieve any built-up pressure as a result in variations in temperature of the fluid. Alternatively, the thermal pressure relief valves 110, 112 may be provided in parallel with the solenoid valves 92, 96 according to another embodiment. According to another embodiment, the thermal relief valves 110, 112 may provided with one for each volume of each biasing member 84, 86. According to yet another embodiment, a single relief valve 110, 112 may be connected to both volumes by check valves. The hydraulic suspension system 76 also includes an accumulator 114 to provide a volume for the fluid to expand into. The accumulator 114 may be set to a low pressure, and given a nominal fluid charge to account for an increase or decrease in temperature.

According to an embodiment, the flow regulation by the proportional valves 90, 94 can be linearly mapped to drive speed for live balancing of the suspension system 76.

According to another embodiment, the hydraulic suspension system 76 is suitable for controlling the axle biasing members 84, 86 at certain travel speeds. The oscillate function permits all four wheels 26 to maintain contact with the ground 22 to maintain stability. At low speeds, the axle 62, 66 motion may be faster than required by the terrain, which can cause the axles 62, 66 to move in a step-wise motion, which may cause discomfort for an operator. Low speeds may be 1.0 miles per hour (mph) and under according to a predetermined range, or even slower, such as 0.5 mph and under, 0.4 mph and under, or 0.3 mph and under. In contrast, maximum speeds are often 4-5 mph, depending upon the particular suspension system 76.

The low speed control dynamics occur when the retracting hydraulic cylinder biasing member 84 or 86 is placed under high load while the land vehicle 20 drives very slowly (0.3 mph and under, or 0.5 mph and under) over an obstacle. When the land vehicle 20 is travelling at higher speeds (greater than 0.3 mph or greater than 0.5 mph, such as 0.7 mph), the oscillation motion is not significantly faster than required by the terrain so that the oscillation system 76 does not overshoot and cause dynamics.

As mentioned above, the suspension system 76 may be provided with a single biasing member 84 according to an embodiment. Under the single biasing member 84 embodiment, the barrel side valve 90 and the rod side valve 92 may each be provided as proportional valves 90, 92. The pair of proportional valves 90, 92 may also employ a redundant load holding valve. The single biasing member 84 system may be suitable for vehicles that have limited stability concerns of the oscillating axle in comparison to aerial work platforms, such as a telescopic handler.

The suspension system 76 is illustrated and described in FIG. 5 as having a proportional valve 90, 94 for each biasing member 84, 86. According to another embodiment, the first biasing member 84 is provided with a pair of proportional valves 90, 92; and the second biasing member 86 is provided with a pair of discrete (on/off) valves 94, 96. The first biasing member 84 provides the control of the suspension adjustment, while second biasing member 86 provides redundant load holding in both directions.

With reference to FIG. 6, the vehicle control module 106 may provide input indicative of wheel torque from a wheel torque sensing system of the vehicle 20. The controller 88 may determine that when one of the wheels 26 is experiencing a low torque relative to other wheels 26, that the low torque wheel 26 is in the air. The controller 88 may utilize the torque data to avoid running a pump when an oscillation of the suspension system 76 is not required. The wheel torque data may be utilized to refine the operation of the suspension system 76, or to cross check the axle sensors 82. For example, if the axle sensors 82 indicate that the axle 62 is not at a pivot limit, but the torque of one of the wheels 26 is near zero torque, while the other three wheels 26 are measuring a substantial torque, a fault may be indicated and reported.

According to another embodiment, the suspension system 76 may utilize a discrete sensor 82 with discrete (on/off) valves 90, 92, 94, 96. By omitting proportional valves, the controller 88 is not required to operate the suspension system 76. A fixed flow control could limit the speed of the biasing members 84, 86, as long as the drive speed of the vehicle 20 is limited to a suitable speed range.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A suspension system for a land vehicle comprising:
a biasing member adapted to be connected to a chassis and a first axle of a land vehicle spaced apart from a pivotal connection of the first axle to pivot the first axle relative to the chassis upon movement to one of a first position and a second position; and
a proportional input in cooperation with the biasing member to permit proportional movement of the biasing member to the first position, and to the second position.

2. The suspension system of claim 1, wherein the biasing member further comprises a fluid biasing member with a first fluid port and a second fluid port; and
wherein the proportional input further comprises a proportional valve assembly in fluid cooperation with the first fluid port of the fluid biasing member to permit fluid to flow to the fluid biasing member to bias the fluid biasing member to the first position, and to permit the fluid to flow from the fluid biasing member to the proportional valve assembly, and to the second fluid port of the fluid biasing member to bias the fluid biasing member to the second position.

3. The suspension system of claim 2 wherein the proportional valve assembly comprises a proportional valve and a second valve in fluid cooperation with the fluid biasing member to permit the fluid to flow from the fluid biasing member and the proportional valve to the second valve, and to the fluid biasing member to bias the fluid biasing member to the second position.

4. The suspension system of claim 2 further comprising a fluid pressure circuit providing the fluid cooperation of the fluid biasing member and the proportional valve assembly.

5. The suspension system of claim 4 wherein the fluid pressure circuit further comprises an inlet to receive pressurized fluid to charge the fluid pressure circuit.

6. The suspension system of claim 4 wherein the fluid pressure circuit further comprises an accumulator.

7. The fluid suspension system of claim 2 further comprising a controller in operable communication with the proportional valve assembly and programmed to:
receive input indicative of unbalanced forces on the first axle; and
adjust the proportional valve assembly in response to the input.

8. The fluid suspension system of claim 2 further comprising a controller in operable communication with the proportional valve assembly and programmed to:
receive input indicative of a travel speed of the land vehicle; and
adjust the proportional valve assembly in response to the travel speed within a predetermined range.

9. The fluid suspension system of claim 2 further comprising a pressure relief valve in parallel with the proportional valve assembly.

10. The fluid suspension system of claim 9 wherein the pressure relief valve further comprises a thermal pressure relief valve.

11. The fluid suspension system of claim 2 wherein the fluid biasing member is further defined as a first fluid biasing member; and
wherein the fluid suspension system further comprises:
a second fluid biasing member with a third fluid port and a fourth fluid port, the second fluid biasing member adapted to be connected to the chassis and the first axle of the land vehicle spaced apart from the pivotal connection of the first axle and spaced apart from the first fluid biasing member to pivot the first axle relative to the chassis upon movement to the first position and the second position, and
a second valve in fluid cooperation with the third fluid port of the second fluid biasing member to permit fluid to flow to the second fluid biasing member to bias the second fluid biasing member to the second position, and to permit the fluid to flow from the second fluid biasing member to the second valve, and to the fourth fluid port of the second fluid biasing member to bias the second fluid biasing member to the first position.

12. A land vehicle comprising:
a chassis;
a first axle pivotally connected to the chassis about a horizontal axis perpendicular to the first axle;
a pair of wheels mounted to the first axle and spaced apart with the pivotal connection therebetween to support the first axle and the chassis for travel upon an underlying support surface;
the fluid suspension system of claim 2, wherein the fluid biasing member is connected to the chassis and the first axle spaced apart from the pivotal connection; and
a fluid pressure circuit in cooperation with the fluid biasing member and the proportional valve assembly.

13. The land vehicle of claim 12 further comprising:
a second axle pivotally connected to the chassis about the horizontal axis perpendicular to the second axle and spaced apart from the first axle;
a second pair of wheels mounted to the second axle and spaced apart with the pivotal connection of the second axle and the chassis therebetween to support the second axle and the chassis for travel upon the underlying support surface; and
a sensor in cooperation with the second axle to detect a pivotal position of the second axle relative to the chassis.

14. A fluid suspension system for a land vehicle comprising:
a fluid biasing member adapted to be connected to a chassis and a first axle of a land vehicle spaced apart from a pivotal connection of the first axle to pivot the first axle relative to the chassis upon movement to a first position and a second position;
a first valve in fluid cooperation with the fluid biasing member to permit fluid to flow to the fluid biasing member to bias the fluid biasing member to the first position; and
a second valve in fluid cooperation with the fluid biasing member and the first valve to permit the fluid to flow from the fluid biasing member to the first valve, to the second valve, and to the fluid biasing member to bias the fluid biasing member to the second position.

15. The fluid suspension system of claim 14 wherein the first valve further comprises a proportional valve.

16. The fluid suspension system of claim 14 further comprising a fluid pressure circuit providing the fluid cooperation of the fluid biasing member, the first valve, and the second valve.

17. The fluid suspension system of claim 16 wherein the fluid pressure circuit further comprises an inlet to receive a pressurized fluid to charge the fluid pressure circuit.

18. The fluid suspension system of claim 14 wherein the fluid biasing member is further defined as a first fluid biasing member; and
wherein the fluid suspension system further comprises:
a second fluid biasing member adapted to be connected to the chassis and the first axle of the land vehicle spaced apart from the pivotal connection of the first axle and spaced apart from the first fluid biasing member to pivot the first axle relative to the chassis upon movement to the first position and the second position,
a third valve in fluid cooperation with the second fluid biasing member to permit fluid to flow to the second fluid biasing member to bias the second fluid biasing member to the second position, and
a fourth valve in fluid cooperation with the second fluid biasing member and the third valve to permit the fluid to flow from the second fluid biasing member to the third valve, to the fourth valve, and to the second fluid biasing member to bias the second fluid biasing member to the first position.

19. A land vehicle comprising:
a chassis;
a first axle pivotally connected to the chassis about a horizontal axis perpendicular to the first axle;
a pair of wheels mounted to the first axle and spaced apart with the pivotal connection therebetween to support the first axle and the chassis for travel upon an underlying support surface;
the fluid suspension system of claim 14, wherein the fluid biasing member is connected to the chassis and the first axle spaced apart from the pivotal connection; and
a fluid pressure circuit in cooperation with the fluid biasing member, the first valve, and the second valve.

20. The land vehicle of claim 19 further comprising:
a second axle pivotally connected to the chassis about the horizontal axis perpendicular to the second axle and spaced apart from the first axle;
a second pair of wheels mounted to the second axle and spaced apart with the pivotal connection of the second axle and the chassis therebetween to support the second axle and the chassis for travel upon the underlying support surface; and
a sensor in cooperation with the second axle to detect a pivotal position of the second axle relative to the chassis.

21. A fluid suspension system for a land vehicle comprising:
a first fluid biasing member adapted to be connected to a chassis and a first axle of a land vehicle spaced apart from a pivotal connection of the first axle to pivot the first axle relative to the chassis upon movement to a first position and a second position;
a second fluid biasing member adapted to be connected to the chassis and the first axle of the land vehicle spaced apart from the pivotal connection of the first axle and spaced apart from the first fluid biasing member to pivot the first axle relative to the chassis upon movement to the first position and the second position;
a first valve in fluid cooperation with the first fluid biasing member to permit fluid to flow to the first fluid biasing member to bias the first fluid biasing member to the first position;
a second valve in fluid cooperation with the first fluid biasing member and the first valve to permit the fluid to flow from the first fluid biasing member to the first valve, to the second valve, and to the first fluid biasing member to bias the first fluid biasing member to the second position;
a third valve in fluid cooperation with the second fluid biasing member and the second valve, to permit fluid to flow from the first fluid biasing member and the second valve to the third valve, and then to the second fluid biasing member to bias the second fluid biasing member to the second position; and
a fourth valve in fluid cooperation with the second fluid biasing member, the first valve, and the third valve to permit the fluid to flow from the first fluid biasing member and the first valve to the fourth valve, and fluid from the second fluid biasing member and the third valve to the fourth valve, and to the second fluid biasing member to bias the second fluid biasing member to the first position.
